(19) United States
(12) Patent Application Publication
(10) Pub. No.: US 2015/0199686 A1
(43) Pub. Date: Jul. 16, 2015

(54) PAYMENT AUTHENTICATION SYSTEM

(71) Applicants: Srinivas Naga BAVIRISETTY, Newark, DE (US); Jyoshna Durga Kalyani Bavirisetty, Newark, DE (US)

(72) Inventors: Srinivas Naga BAVIRISETTY, Newark, DE (US); Jyoshna Durga Kalyani Bavirisetty, Newark, DE (US)

(21) Appl. No.: 14/595,055

(22) Filed: Jan. 12, 2015

Related U.S. Application Data
(60) Provisional application No. 61/926,278, filed on Jan. 11, 2014.

(51) Int. Cl. G06Q 20/40

(52) U.S. Cl. CPC G06Q 20/401

(57) ABSTRACT

A method for completing a transaction based on a wallet-less authentication system is provided. The system embodying the method may be operatively connected to at least one server comprising a plurality of customer profiles and registered merchants, wherein each customer profile comprises payment account information and at least one corresponding verified customer image. The payment account information comprises at least one payment card, each associated with a pin number. The at least one server may be configured to execute a payment authorization module and an authentication module comprising the following: receiving a request to authorize the wallet-less payment from at least one payment card to the registered merchant, wherein the request includes a putative pin number; verifying whether the putative pin number and the customer pin number are a match; transmitting the customer image to the registered merchant; and generating, in response to the match, a request of customer image verification from the registered merchant.

### CROSS-REFERENCE TO RELATED APPLICATION

This application claims the benefit of priority of U.S. provisional application No. 61/926,278, filed 11 Jan. 2014, the contents of which are herein incorporated by reference.

### BACKGROUND OF THE INVENTION

The present invention relates to a method to authorize a mobile payment for a transaction and, more particularly, to a payment authorization method for completing a transaction based on a wallet-less authentication system.

Today, most of the population in this world makes their purchases using credit cards; however, these same people holds multiple credit cards that need to be carried in a wallet or purse in order to use all of them. Moreover, merchants have to invest money on credit card swiping machines and pay their attendant maintenance fees in order to process or accept a credit card payment from the customer. Also banks have to maintain payment gateways for individual merchants.

As can be seen, there is a need for a payment authorization method for completing a transaction based on a wallet-less authentication system.

### SUMMARY OF THE INVENTION

In one aspect of the present invention, a system to authorize a wallet-less payment for a transaction with a registered merchant of at least one system server, wherein the registered merchant has a user interface operatively connected to the at least one system server comprises: at least one computer operatively connected to the at least one system server; a program product comprising machine-readable program code for causing, when executed, the at least one computer to perform the following process steps: prompting a user to register a customer profile on the at least one system server; prompting the user for payment account information and a customer image for the customer profile, wherein the payment account information comprises a customer pin number associated with each payment card; receiving the customer image and payment account information from the user; receiving a request to authorize the wallet-less payment from at least one payment card to the registered merchant, wherein the request includes a putative pin number; verifying whether the putative pin number and the customer pin number are a match; and generating, in response to the match, a request of customer image verification from the registered merchant.

In another aspect of the present invention, the system further provides electronically representing the customer image on the user interface of the registered merchant.

In yet another aspect of the present invention, the system further provides a security key server operatively connected to the at least one system server, wherein the security key server provides a trusted security key for authorizing the transaction, and wherein the request includes a putative security key; and verifying whether the putative security key and the trusted security key are a verification, wherein the security key is one hundred percent live updated.

These and other features, aspects and advantages of the present invention will become better understood with reference to the following drawings, description and claims.

### BRIEF DESCRIPTION OF THE DRAWINGS

FIG. 1 depicts a schematic block diagram of an exemplary embodiment of a customer registration of the present invention;

FIG. 2 depicts a schematic block diagram of an exemplary embodiment of a registration authentication process of the present invention;

FIG. 3 depicts a schematic block diagram of an exemplary embodiment of a merchant account registration of the present invention;

FIG. 4 depicts a schematic block diagram of an exemplary embodiment of a payment authorization module of the present invention;

FIG. 5 depicts a schematic block diagram of an exemplary embodiment of the payment authorization module of the present invention;

FIG. 6 depicts a schematic block diagram of an exemplary embodiment of the payment authorization module of the present invention;

FIG. 7 depicts a schematic block diagram of an exemplary embodiment of the payment authorization module of the present invention;

FIG. 8 depicts a schematic block diagram of an exemplary embodiment of a coupon module of the present invention;

FIG. 9 depicts a schematic block diagram of an exemplary embodiment of an e-receipt process of the present invention; and

FIG. 10 depicts a schematic block diagram of an exemplary embodiment of a prediction process of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for completing a transaction based on a wallet-less authentication system. The system embodying the method may be operatively connected to at least one server comprising a plurality of customer profiles and registered merchants, wherein each customer profile comprises payment account information and at least one corresponding verified customer image. The payment account information comprises at least one payment card, each associated with a pin number. The at least one server may be configured to execute a payment authorization module and an authentication module comprising the following: receiving a request to authorize the wallet-less payment from at least one payment card to the registered merchant, wherein the request includes a putative pin number; verifying whether the putative pin number and the customer pin number are a match; transmitting the customer image to the registered merchant; and generating, in response to the match, a request of customer image verification from the registered merchant.

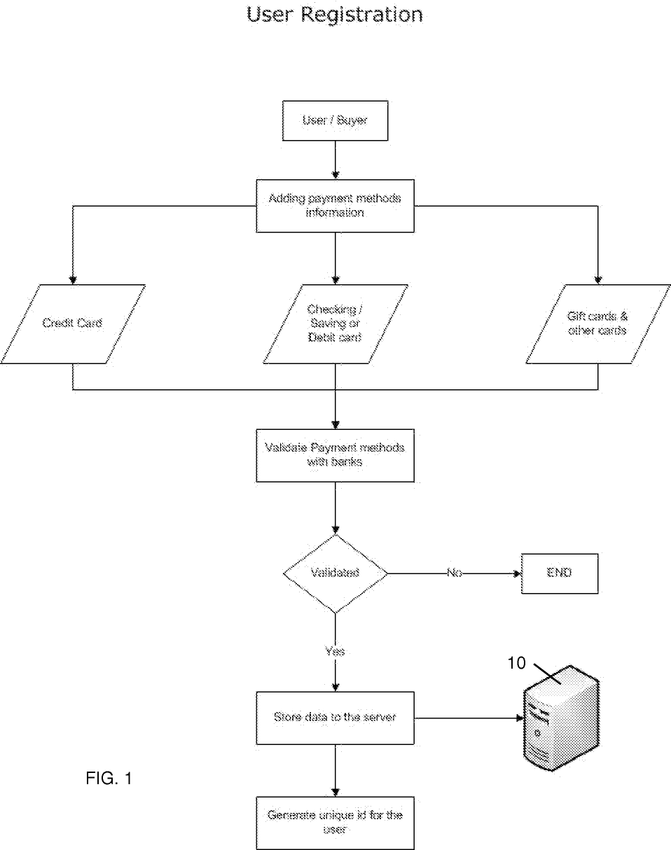

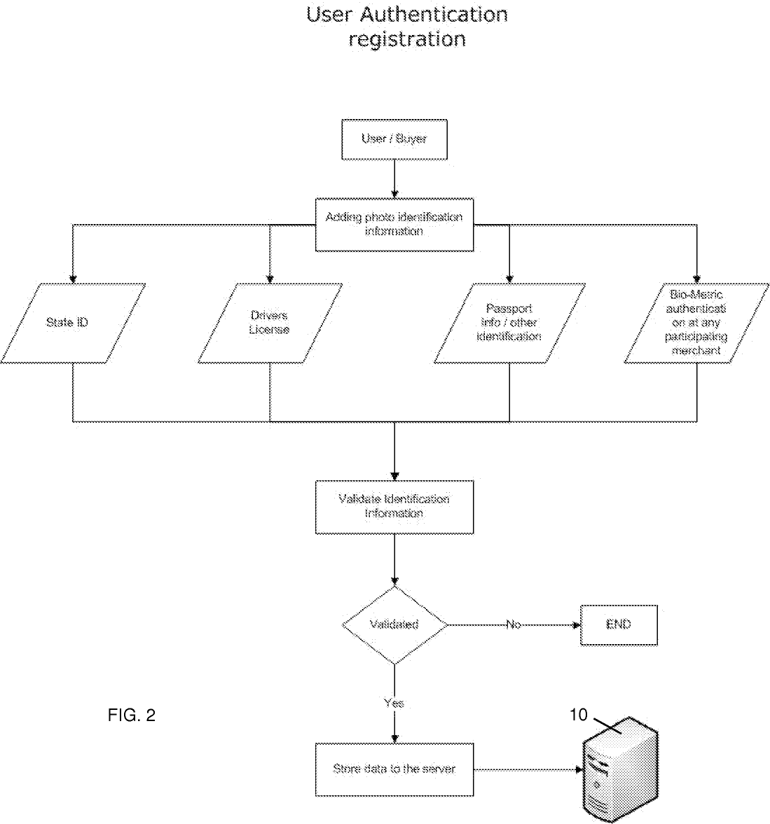

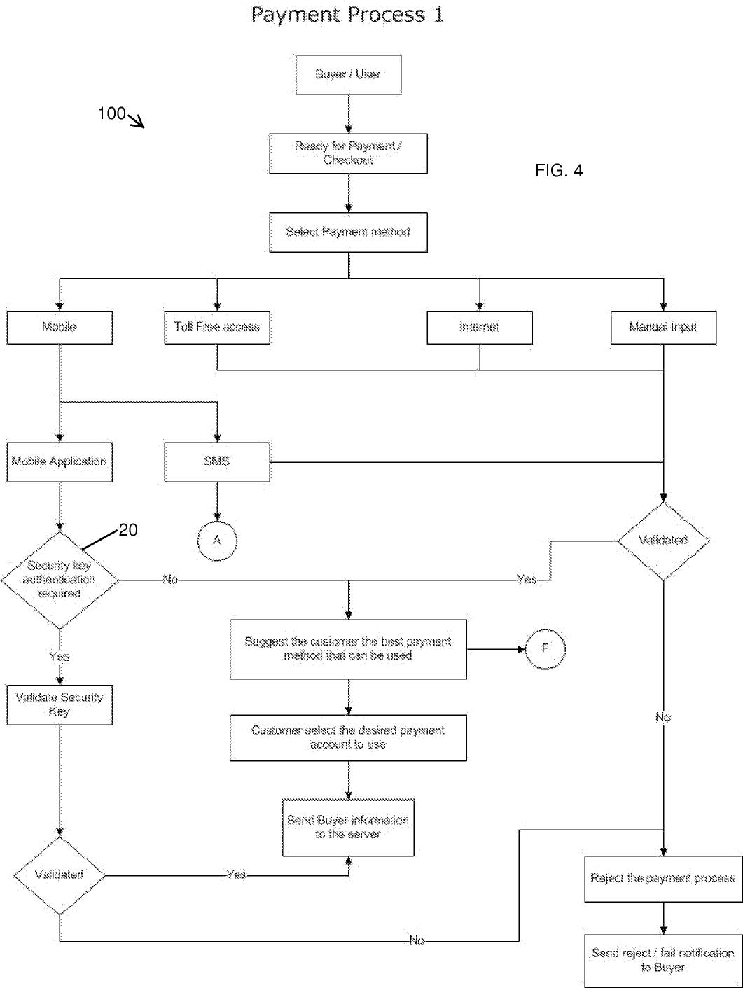

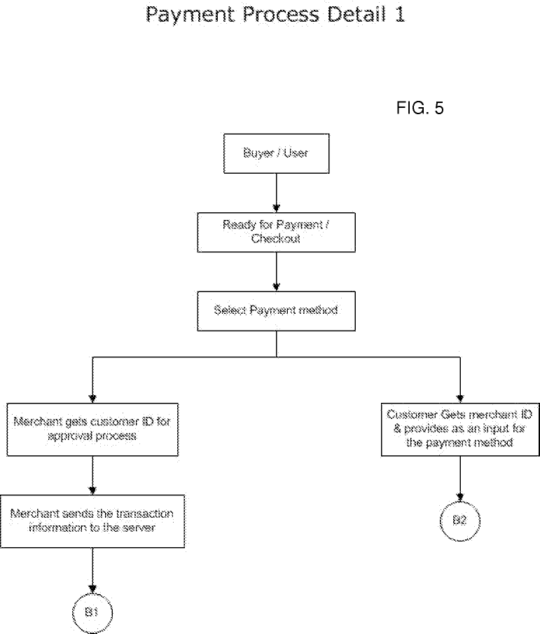

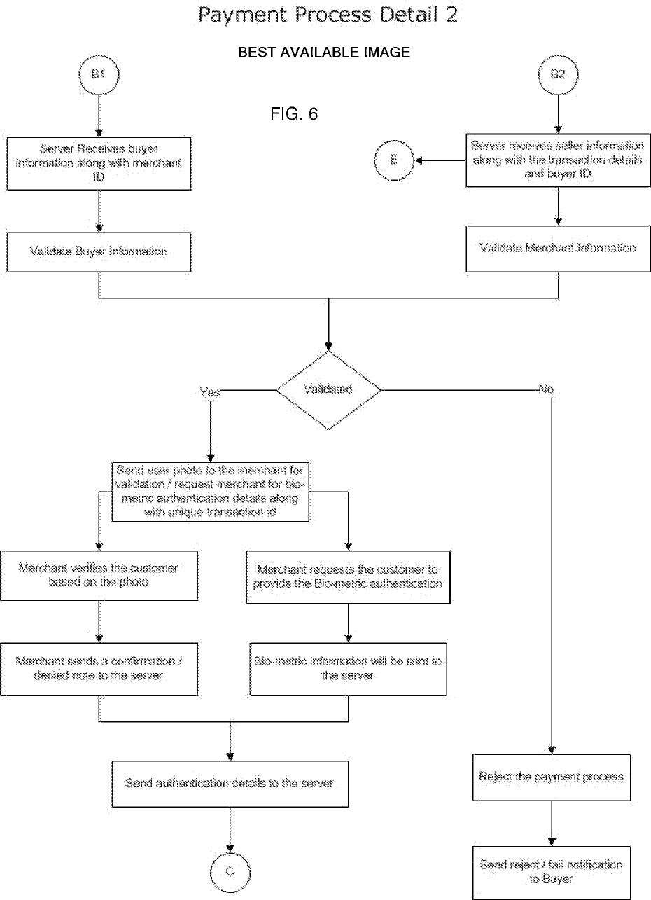

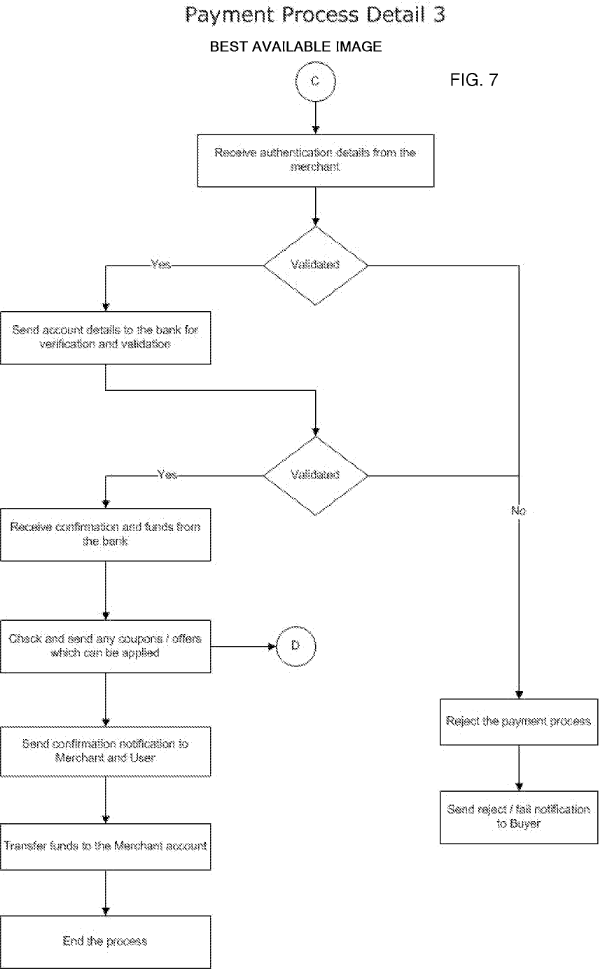

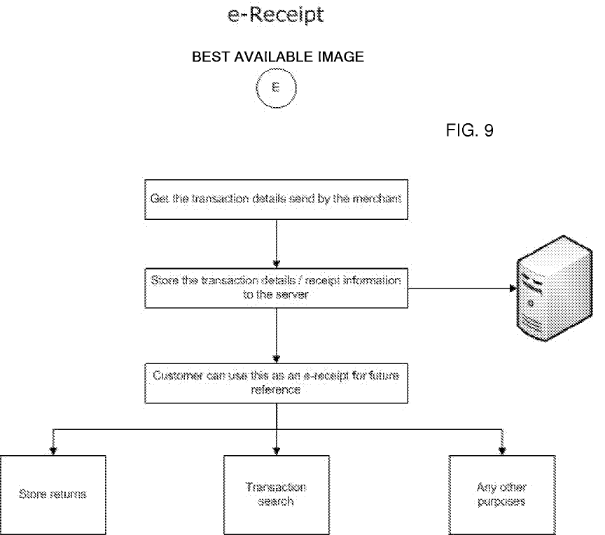

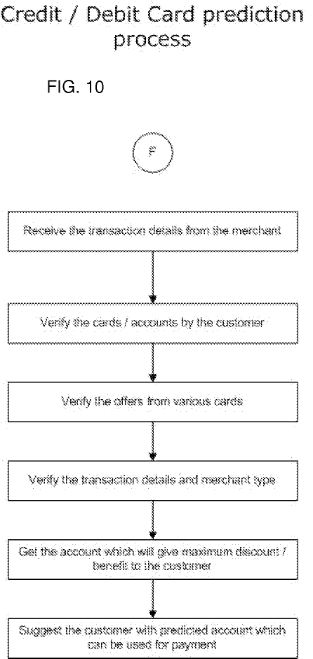

Referring to FIGS. 1 through 10, the present invention may include a payment system 100 embodying a method for completing a transaction based on a wallet-less authentication system. The payment system 100 may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The payment system 100 may include various components coupled via computer network. For example, the computer network may include wired and/or wireless portions of the Internet and/or other data communications networks such as wide area networks (WANs), local area networks (LANs), etc. The payment system 100 may be operatively connected to at least one system server 10.

The at least one system server 10 may be configured to store a plurality of customer profiles (e.g., customer number and at least one corresponding verified customer image) and merchant account information, and configured to execute a payment authorization module, an authentication module and a coupon module. The stored customer profile and merchant account information (and/or any of the data items stored therein) may be a data store such as a database, a file system, one or more data structures (e.g., arrays, link lists, tables, hierarchical data structures, etc.) configured in a memory, an extensible markup language (XML) file, any other suitable medium for storing data, or any suitable combination thereof.

Each customer profile may be initially stored through a registration process illustrated in FIG. 1. The customer profile may include customer identification information, activated device information and payment account information. The customer identification information may include a customer number, at least one pin number, and the at least one corresponding verified customer image. The customer number may be generated by the system 100 upon initial registration. The system 100 may prompt a user/customer to upload the at least one corresponding verified customer images associated with the customer identification information. Each customer image may be a photographed image of the associated user/customer, or other image whereby a registered merchant may identify the associated user/customer. The payment account information may include account number, card number and other pertinent information of each payment card—such as credit card, gift card, debit card issued by a financial institution or a registered merchant associated with the user/customer. The system 100 may prompt a user to create a pin number to be associated with each credit card, gift card, debit card and the like. The activated device information may include at least one registered device the system 100 verifies during the authentication module. A registered device may be a phone, a cell phone, a laptop, mobile device, computer and the like. The smart devices may operate SMS, Mobile apps or the like.

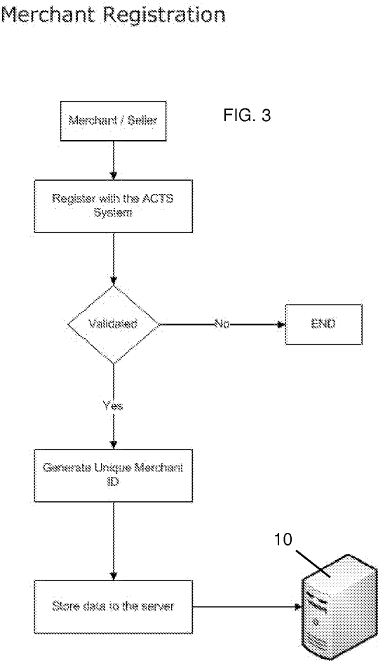

The merchant account information may be initially stored through a registration process illustrated in FIG. 3. The merchant account may include merchant identification information associated with the registered merchant.

The authentication module may be dedicated to authentication based on customer image verification in conjunction with a number verification based on additional and separate authorization criteria to generate the overall authorization of a predetermined payment/transaction with a predetermined registered merchant.

The number verification may include verification of the customer number and the pin number of the associated card numbers. In one or more embodiments, the number verification may include the customer communicating by the registered device to the payment system 100. Customer will use the pin number associated with the card number to be used as part of the predetermined payment/transaction. In this way customer doesn't require to provide any secured information including any combination of credit card number, CVV etc.

In certain embodiments, the system 100 may ask the customer for an e-Signature if the customer is using a non-registered device, using a device not associated with the activated device information, based on the merchant or banker settings, or the like. In certain embodiments, the system uses security token and/or soft key token if the customer wants a secured mobile app. The security token may include, but not be limited to, a hardware token, authentication token, USB token, cryptographic token, software token, virtual token, or key fob. The security token is continuously being updated on the system 100 so as to be one hundred percent live updated. As part of this authorization the system 100 also gets the security token from the mobile app and sends the same to the system server 10 to validate. Now the system server 10 will interact with an operatively integrated security token server 20 and will validate the security token, if it is validated then the predetermined payment/transaction will proceed. The security key server 20 may be operatively connected to the at least one system server 10, wherein the security key server 20 provides the trusted security key for authorizing a transaction, especially when using the secured mobile app. Transactions may require a verification of a trusted security key from the security key server and a putative security key embodied in a request for the transaction.

If the system 100 authenticates the number verification information provided by the customer is reconciled with the customer identification information, the customer receives a number confirmation. After receiving number confirmation, the system server 10 will get the authorization from the bank and will process the payment to the merchant through the payment authorization module. The payment authorization module is integrated with the authentication module. The server sends a confirmation receipt to the merchant when the payment is authorized.

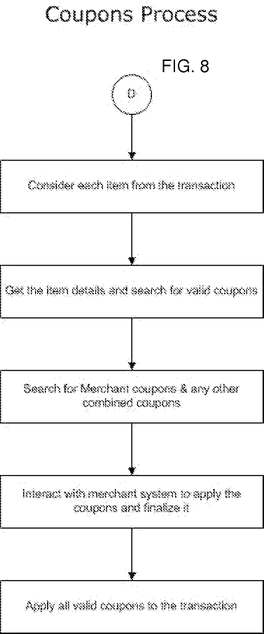

During the authentication module, the system 100 may verify and validate actionable coupons pursuant to the coupon module, as illustrated in FIG. 8. The coupon module can be applied to the predetermined payment/transaction (if it is setup of sending the transaction details from the predetermined registered merchant). The actionable coupons may be stored in the registered merchant account of the system 100 associated with the predetermined payment/transaction.

The customer image verification provides the predetermined registered merchant the customer image while customer is obtaining number verification. The predetermined registered merchant will validate the customer is the right person or not by looking at the image and the would-be customer. The merchant can decline the payment process if the photo is not validated with the customer. Thereby the customer without a computer, smart device or standard cell phone may engage a registered merchant in a secure payment transaction. The system 100 may provide a plurality of additional bio-metric verification criteria, when the customer image verification is inapplicable.

This system can be used even in ATM's to withdraw the money following the same security levels. The system also provides a very high security to the customer who may be held by thieves. The user/customer can pre-configure a emergency number during the registration that may be utilized at the time of withdrawal. This informs a message to the nearest police station so that the customer and their monies can be rescued.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system to authorize a wallet-less payment for a transaction with a registered merchant of at least one system server, wherein the registered merchant has a user interface operatively connected to the at least one system server, comprising:
at least one computer operatively connected to the at least one system server;
a program product comprising machine-readable program code for causing, when executed, the at least one computer to perform the following process steps:
prompting a user to register a customer profile on the at least one system server;
prompting the user for payment account information and a customer image for the customer profile, wherein the payment account information comprises a customer pin number associated with each payment card;
receiving the customer image and payment account information from the user;
receiving a request to authorize the wallet-less payment from at least one payment card to the registered merchant, wherein the request includes a putative pin number;
verifying whether the putative pin number and the customer pin number are a match; and
generating, in response to the match, a request of customer image verification from the registered merchant.

2. The system of claim 1, further providing electronically representing the customer image on the user interface of the registered merchant.

3. The system of claim 1, further including providing a security key server operatively connected to the at least one system server, wherein the security key server provides a trusted security key for authorizing the transaction, and wherein the request includes a putative security key; and verifying whether the putative security key and the trusted security key are a verification.

4. The system of claim 3, wherein the security key is one hundred percent live updated.

5. The system of claim 1, further providing a coupon module for verifying and validating action coupons associated with the registered merchant.

6. A method for authorizing a wallet-less payment for a transaction with a registered merchant of a system operatively connected to at least one system server, wherein the registered merchant has a user interface operatively connected to the at least one system server, comprising:
providing at least one computer operatively connected to the at least one system server;
prompting a user to register a customer profile on the at least one system server;
prompting the user for payment account information and a customer image for the customer profile, wherein the payment account information comprises a customer pin number associated with each payment card;
receiving the customer image and payment account information from the user;
receiving a request to authorize the wallet-less payment from at least one payment card to the registered merchant, wherein the request includes a putative pin number;
verifying whether the putative pin number and the customer pin number are a match; and
generating, in response to the match, a request of customer image verification from the registered merchant.

7. The method of claim 6, further providing electronically representing the customer image on the user interface of the registered merchant.

8. The method of claim 6, further including providing a security key server operatively connected to the at least one system server, wherein the security key server provides a trusted security key for authorizing the transaction, and wherein the request includes a putative security key; and verifying whether the putative security key and the trusted security key are a verification.

9. The method of claim 8, wherein the security key is one hundred percent live updated.

10. The method of claim 6, further providing a coupon module for verifying and validating action coupons associated with the registered merchant of the system.

11. The method of claim 6, wherein the registered merchant verifies the request of customer image verification,
whereby a phoneless, wallet-less payment for a transaction with a registered merchant of the system has been authorized.
